(19) United States
(12) Patent Application Publication
(10) Pub. No.: US 2026/0018787 A1
(43) Pub. Date: Jan. 15, 2026

(54) PHASE SHIFTER AND ANTENNA

(71) Applicants: Beijing BOE Technology Development Co., Ltd., Beijing (CN); BOE Technology Group Co., Ltd., Beijing (CN)

(72) Inventors: Shiqiao ZHANG, Beijing (CN); Jia FANG, Beijing (CN); Feng QU, Beijing (CN); Cheng PAN, Beijing (CN); Yu LUO, Beijing (CN); Yang ZHENG, Beijing (CN)

(21) Appl. No.: 18/994,135

(22) PCT Filed: Mar. 13, 2024
(86) PCT No.: PCT/CN2024/081517

§ 371 Date: Jan. 14, 2025

(30) Foreign Application Priority Data
Apr. 24, 2023 (CN) 202310450022.7

(51) Int. Cl. H01Q 3/36; H01Q 1/38; H01Q 1/48; H01Q 21/00; H01Q 21/06

(52) U.S. Cl. CPC H01Q 3/36; H01Q 1/38; H01Q 1/48; H01Q 21/0006; H01Q 21/061

(57) ABSTRACT

The present disclosure discloses a phase shifter and an antenna. A metal electrode layer is provided with a grid pattern, and a plurality of coupling ports are provided on a side of a second substrate facing away from a first substrate, so that electromagnetic waves may be propagated in two dimensions. That is, the phase shifter of the present disclosure is a phase shifter based on a two-dimensional transmission line. Coupling transmission of signal energy may be carried out on the surface of the two-dimensional transmission line. Therefore, coupling of signal energy with different phase shift amount may be implemented by means of the plurality of coupling ports, so that signals and energy may be extracted at different coupling ports, and electromagnetic waves having different phases may be simultaneously outputted at different coupling port, which is equivalent to a plurality of phase shifters working at the same time.

### CROSS-REFERENCE TO RELATED APPLICATIONS

This application is a national phase entry under 35 U.S.C. § 371 of International Application No. PCT/CN2024/081517, filed on Mar. 13, 2024, which claims priority to Chinese Patent Application No. 202310450022.7, filed with the China National Intellectual Property Administration on Apr. 24, 2023 and entitled “Phase Shifter and Antenna”, the entire contents of which are incorporated herein by reference.

### TECHNICAL FIELD

The present disclosure relates to the field of communication technology, and in particular to a phase shifter and an antenna.

### BACKGROUND

A phase shifter is a device that can adjust the phase of a microwave signal (electromagnetic wave), is widely used in electronic communication systems, and is a core component in phased array radars, synthetic aperture radars, radar electronic countermeasures, satellite communications, and transceivers.

### SUMMARY

Embodiments of the present disclosure provide a phase shifter and an antenna, in which microwave signals and energy can propagate in a two-dimensional space, thereby greatly improving the flexibility of the phase shifter.

Embodiments of the present disclosure provide a phase shifter, including: a first base substrate and a second base substrate arranged opposite to each other; a dielectric layer between the first base substrate and the second base substrate; and a plurality of coupling ports arranged at interval on a side of the second base substrate away from the first base substrate.

The first base substrate includes a first substrate and a ground metal layer located on a side of the first substrate facing the dielectric layer. The second base substrate includes a second substrate and an electrode structure located on a side of the second substrate facing the dielectric layer.

The electrode structure includes a metal electrode layer and a transparent electrode layer. The metal electrode layer is provided with a grid pattern. The transparent electrode layer includes a plurality of transparent conductive portions distributed in an array. The orthographic projection of the transparent conductive portions on the first substrate and the orthographic projection of the grid pattern of the metal electrode layer on the first substrate do not overlap with each other.

In some embodiments, in the phase shifter provided in embodiments of the present disclosure, the metal electrode layer includes a plurality of metal wires that are crisscrossed and spaced apart. The plurality of metal wires form the grid pattern.

The transparent conductive portions are arranged in meshes of the grid pattern.

In some embodiments, in the phase shifter provided in embodiments of the present disclosure, the width of the metal wire is less than one thirtieth of the wavelength of the operating frequency of the phase shifter.

In some embodiments, in the phase shifter provided in embodiments of the present disclosure, the shape of the mesh includes at least one of square, circle, triangle, or a Z-shape. The side length of the square, the diameter of the circle, the side length of the triangle, and the vertical distance between the two horizontal sides of the Z-shape are all less than one tenth of the wavelength of the operating frequency of the phase shifter.

In some embodiments, in the phase shifter provided in embodiments of the present disclosure, the number of the transparent conductive portions arranged in each mesh is greater than or equal to one.

In some embodiments, in the phase shifter provided in embodiments of the present disclosure, the metal wire includes a straight line or a curved line.

In some embodiments, in the phase shifter provided in embodiments of the present disclosure, an orthographic projection of one coupling port on the first substrate covers an orthographic projection of a plurality of meshes on the first substrate.

In some embodiments, in the phase shifter provided in embodiments of the present disclosure, the metal electrode layer includes a plurality of block sub-electrodes distributed in an array. Gaps between the plurality of block sub-electrodes form the grid pattern.

The transparent conductive portions are disposed at the gaps between the plurality of block sub-electrodes.

In some embodiments, in the phase shifter provided in embodiments of the present disclosure, an orthographic projection of one coupling port on the first substrate covers an orthographic projection of a plurality of transparent conductive portions on the first substrate.

In some embodiments, in the phase shifter provided in embodiments of the present disclosure, the shape of the coupling port includes at least one of the following: an “I”-shaped port, a rectangular port, a “+”-shaped port, and an “I”-shaped port.

In some embodiments, the phase shifter provided in embodiments of the present disclosure further includes bias voltage lines arranged in the same layer and made of the same material as the transparent conductive portions. The second substrate is divided into multiple areas. The transparent conductive portions in the same area are electrically connected to the same bias voltage line, and the transparent conductive portions in different areas are electrically connected to different bias voltage lines.

In some embodiments, in the phase shifter provided in embodiments of the present disclosure, the shape of the transparent conductive portion includes at least one of the following: rhombus, rectangle, circle, or triangle.

In some embodiments, in the phase shifter provided in embodiments of the present disclosure, the thickness of the ground metal layer and the thickness of the metal electrode layer are both greater than

$$\sqrt{\frac{2}{ω μ γ}} .$$

Here, ω is the angular frequency, μ is the magnetic permeability, and γ is the electrical conductivity.

In some embodiments, in the phase shifter provided in embodiments of the present disclosure, the material of the first substrate and the material of the second substrate are flexible materials.

Correspondingly, embodiments of the present disclosure further provide an antenna, including the above-mentioned phase shifter provided by embodiments of the present disclosure.

### BRIEF DESCRIPTION OF DRAWINGS

In order to more clearly illustrate the technical solutions in the embodiments of the present disclosure, the drawings required for use in the description of the embodiments will be briefly introduced below. Obviously, the drawings described below are only some embodiments of the present disclosure. For ordinary technicians in this field, other drawings can be obtained based on these drawings without paying creative work.

FIG. 1 is a cross-sectional schematic diagram of a phase shifter provided in an embodiment of the present disclosure.

FIG. 2 is a schematic plan view of a metal electrode layer.

FIG. 3 is a schematic plan view of a transparent electrode layer.

FIG. 4 is a schematic plan view of a metal electrode layer and a transparent electrode layer.

FIG. 5 is a partial enlarged schematic diagram of FIG. 2.

FIG. 6 is a partial enlarged schematic diagram of FIG. 4.

FIG. 7 is another partial enlarged schematic diagram of a mesh and a transparent conductive portion.

FIG. 8 is another partial enlarged schematic diagram of a mesh and a transparent conductive portion.

FIG. 9 is another partial enlarged schematic diagram of a mesh and a transparent conductive portion.

FIG. 10 is another partial enlarged schematic diagram of a mesh and a transparent conductive portion.

FIG. 11 is another partial enlarged schematic diagram of a mesh and a transparent conductive portion.

FIG. 12 is another partial enlarged schematic diagram of a mesh and a transparent conductive portion.

FIG. 13 is another partial enlarged schematic diagram of a mesh and a transparent conductive portion.

FIG. 14 is another schematic plan view of a metal electrode layer.

FIG. 15 is another schematic plan view of a metal electrode layer.

FIG. 16 is another schematic plan view of a metal electrode layer.

FIG. 17 is a schematic diagram of a planar structure of a coupling port.

FIG. 18 is a schematic diagram of another planar structure of a coupling port.

FIG. 19 is a schematic diagram of another planar structure of a coupling port.

FIG. 20 is a schematic diagram of another planar structure of a coupling port.

FIG. 21 is another schematic plan view of a transparent electrode layer.

FIG. 22 is a schematic diagram of a simulation of the reflection coefficient between an electromagnetic wave input port (port1) and an electromagnetic wave output port (port2) of a liquid crystal phase shifter based on a two-dimensional transmission line shown in FIG. 1.

FIG. 23 is a schematic diagram of a simulation of the transmission coefficient between an electromagnetic wave input port (port1) and an electromagnetic wave output port (port2) of a liquid crystal phase shifter based on a two-dimensional transmission line shown in FIG. 1.

FIG. 24 is a schematic diagram of a simulation of the phase shift amount between an electromagnetic wave input port (port1) and an electromagnetic wave output port (port2) of a liquid crystal phase shifter based on a two-dimensional transmission line shown in FIG. 1.

### DETAILED DESCRIPTION

In order to make the purpose, technical solution and advantages of the embodiments of the present disclosure more clear, the technical solution of the embodiments of the present disclosure will be clearly and completely described below in conjunction with the drawings of the embodiments of the present disclosure. Obviously, the described embodiments are only part of the embodiments of the present disclosure, rather than all the embodiments. Furthermore, the embodiments in the present disclosure and the features in the embodiments may be combined with each other without conflict. Based on the described embodiments of the present disclosure, all other embodiments obtained by ordinary technicians in the field without creative work are within the scope of protection of the present disclosure.

Unless otherwise defined, technical or scientific terms used in the present disclosure should have the common meanings understood by a person having ordinary skills in the field to which the present disclosure belongs. The terms “first”, “second” and the like used in the present disclosure do not indicate any order, quantity or importance, but are only used to distinguish different components. The words “include” or “comprise” and the like mean that the elements or objects preceding the words include the elements or objects listed after the words and their equivalents, but do not exclude other elements or objects. The words “connect” or “couple” and the like are not limited to physical or mechanical connections, but may include electrical connections, whether direct or indirect.

It should be noted that the size and shape of each figure in the accompanying drawings do not reflect the actual proportion, and the purpose is only to illustrate the contents of the present disclosure. And the same or similar reference numerals throughout represent the same or similar elements or elements having the same or similar functions.

Microwave transmission lines commonly used in phase shifters include microstrip lines, coaxial lines, metal waveguides, etc. Microwaves propagate in one dimension along the transmission line. The performance of one-dimension transmission is stable and excellent for point-to-point signal transmission, such as antenna feeding and analog signal connection. However, when there are many components that need to be connected, especially in the large-scale sensor network technology of the Internet of Things, the components are small and dense, the wiring complexity of one-dimensional transmission increases dramatically. The high wiring cost will greatly reduce the practicality of the design and lack flexibility. In addition, in the field of array antennas, complex feeding networks will make the wiring of one-dimensional transmission be complicated and increase losses, thereby reducing the performance of array antennas.

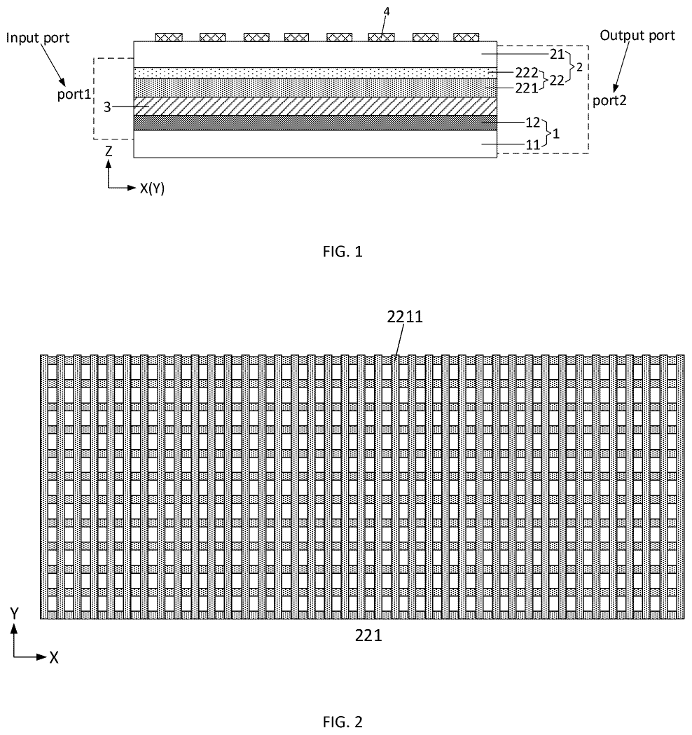

In order to solve the above problems, embodiments of the present disclosure provide a phase shifter. As shown in FIG. 1, the phase shifter includes: a first base substrate 1 and a second base substrate 2 arranged opposite to each other, a dielectric layer 3 between the first base substrate 1 and the second base substrate 2, and a plurality of coupling ports 4 arranged on a side of the second base substrate 2 facing away from the first base substrate 1 and spaced apart from each other.

The first base substrate 1 includes a first substrate 11 and a ground metal layer 12 on a side of the first substrate 11 facing the dielectric layer 3. The second base substrate 2 includes a second substrate 21 and an electrode structure 22 on a side of the second substrate 21 facing the dielectric layer 3. The electrode structure 22 includes a metal electrode layer 221 and a transparent electrode layer 222.

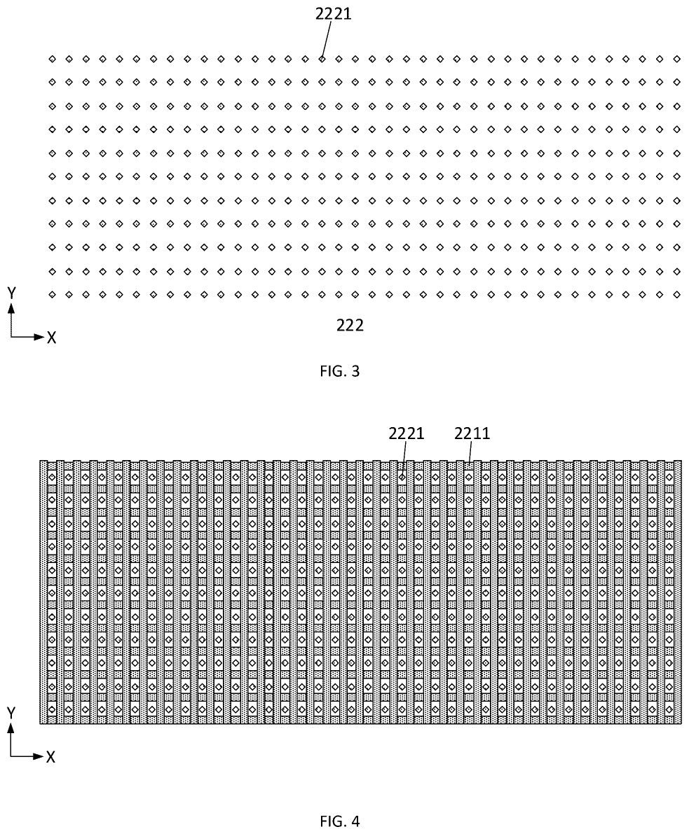

As shown in FIG. 2, FIG. 2 is a schematic plan view of a metal electrode layer 221. The metal electrode layer 221 has a grid pattern. As shown in FIG. 3, FIG. 3 is a schematic plan view of a transparent electrode layer 222. The transparent electrode layer 222 includes a plurality of transparent conductive portions 2221 distributed in an array. As shown in FIG. 4, FIG. 4 is a schematic plan view of a metal electrode layer 221 and a transparent electrode layer 222. The orthographic projection of the transparent conductive portion 2221 on the first substrate 11 and the orthographic projection of the grid pattern 2211 of the metal electrode layer 221 on the first substrate 11 do not overlap with each other.

In the phase shifter provided by embodiments of the present disclosure, the metal electrode layer has a grid pattern. A plurality of coupling ports are arranged on the side of the second base substrate away from the first base substrate, so that the electromagnetic wave can propagate in two dimensions (a direction parallel to the first base substrate and a direction perpendicular to the first base substrate). That is, the phase shifter provided by the present disclosure is a phase shifter based on a two-dimensional transmission line. Signal energy can be coupled and transmitted on the surface of the two-dimensional transmission line, so that coupling of signal energy with different phase shift amounts can be achieved through a plurality of coupling ports, and signals and energy can be extracted at different coupling ports.

Electromagnetic waves with different phases can be output simultaneously at different coupling ports, which is equivalent to multiple phase shifters working simultaneously. Therefore, compared with the traditional phase shifter based on a one-dimensional transmission line, the phase shifter based on a two-dimensional transmission line provided by the present disclosure has higher flexibility. In addition, the phase shifter based on a two-dimensional transmission line provided by the present disclosure has a relatively simple structure, a low manufacturing cost, can be laid over a large area, and has strong practicality.

As shown in FIG. 1, the dielectric constant of the dielectric layer 3 can change according to the change of the electric field between the ground metal layer 12 and the electrode structure 22. For example, the dielectric layer 3 may be a liquid crystal layer 3. Liquid crystal is an anisotropic material with different dielectric constants along the long axis and short axis. When a bias voltage is applied at two ends of the liquid crystal, the liquid crystal will deflect, so that in a certain direction, the dielectric constant of the liquid crystal changes with the change of the bias voltage. Of course, the dielectric layer 3 in the present disclosure may also be made of other materials similar to liquid crystal that can change the dielectric constant based on changes in the electric field, such as graphene, polymer dispersed liquid crystal (PDLC), etc. In order to improve the response time of the phase shifter, PDLC can be used. In the present disclosure, the dielectric layer 3 is taken as a liquid crystal layer 3 for illustration. Different types of liquid crystals have different adjustable dielectric constants, and appropriate liquid crystals need to be used according to the required dielectric constants.

In some embodiments, as shown in FIG. 1, the thickness of the liquid crystal layer 3 has a certain influence on the electromagnetic wave coupling strength. The thickness of the liquid crystal layer 3 should not be too large. The thickness of the liquid crystal layer 3 used in the present disclosure is less than 100 μm. Preferably, the thickness of the liquid crystal layer 3 is 8.6 μm.

For example, as shown in FIG. 1, after a voltage is applied to the ground metal layer 12 and the electrode structure 22, an electric field is formed between the ground metal layer 12 and the electrode structure 22 to deflect the liquid crystal molecules in the liquid crystal layer 3, thereby changing the dielectric constant of the liquid crystal layer 3 to change the phase of the microwave signal transmitted to the liquid crystal layer 3, so as to achieve the purpose of phase shifting.

Optionally, the first substrate and the second substrate can be commonly used PCB insulating materials such as polytetrafluoroethylene glass fiber laminate, phenolic paper laminate, phenolic glass cloth laminate, etc., or can be hard materials with low microwave signal loss such as quartz and glass, or can be flexible materials such as polyimide (PI), polyethylene terephthalate (PET), etc.

Preferably, the material of the first substrate and the material of the second substrate are flexible materials, so that the liquid crystal phase shifter based on a two-dimensional transmission line provided by the present disclosure can be easily conformal to other structures, thereby improving the application scenarios of the liquid crystal phase shifter.

In some embodiments, in the phase shifter provided in embodiments of the present disclosure, as shown in FIG. 1 to FIG. 4, the metal electrode layer 221 includes a plurality of metal wires (i.e., grid pattern 2211) that are crisscrossed and spaced apart in horizontal (X) and longitudinal (Y) directions. The plurality of metal wires 2211 form a grid pattern.

The transparent conductive portions 2221 are disposed in the meshes of the grid pattern. For example, the metal wires 2211 crisscrossed in the horizontal direction X and the longitudinal direction Y in the metal electrode layer 221 are used as transmission lines for transmitting electromagnetic waves. The area of the transparent conductive portion 2221 is smaller than the area of the mesh. The transparent electrode layer 222 is loaded with a driving voltage through a bias voltage line to ensure the deflection of the liquid crystal layer 3. The ground metal layer 12 is loaded with a common voltage, for example, to transmit electromagnetic waves to the metal wires 2211 in the horizontal direction X. Due to the arrangement of multiple coupling ports 4, the electromagnetic waves can be coupled in the horizontal direction X and in a direction (Z) perpendicular to the first substrate 11 at the same time. That is, the phase shifter provided in the present disclosure is a phase shifter based on a two-dimensional transmission line and has high flexibility. Of course, electromagnetic waves can also be transmitted to the metal wires 2211 in the longitudinal direction Y, so that the electromagnetic waves can be coupled along the longitudinal direction Y and the direction (Z) perpendicular to the first substrate 11 at the same time. Electromagnetic waves can also be transmitted to the metal wires 2211 in the horizontal direction X and the longitudinal direction Y at the same time, so that the electromagnetic waves can be coupled along the horizontal direction X, the longitudinal direction Y and the direction (Z) perpendicular to the first substrate 11 at the same time. The transmission method of the electromagnetic waves is selected according to actual needs.

For example, the two-dimensional transmission line in a liquid crystal phase shifter based on a two-dimensional transmission line structure provided by the present disclosure is a slow-wave transmission structure. The slow-wave transmission characteristics mainly come from the grid boundary conditions of the periodic grid pattern on the upper surface of the liquid crystal layer 3. Among the metal wires that cross horizontally and longitudinal on the two-dimensional transmission line, the metal wires along the propagation direction (such as the horizontal X) are mainly used to transmit electromagnetic waves, while metal wires along the longitudinal Y perpendicular to the propagation direction are mainly used to construct a displacement current loop, thereby extending the current path and realizing its slow-wave transmission characteristics.

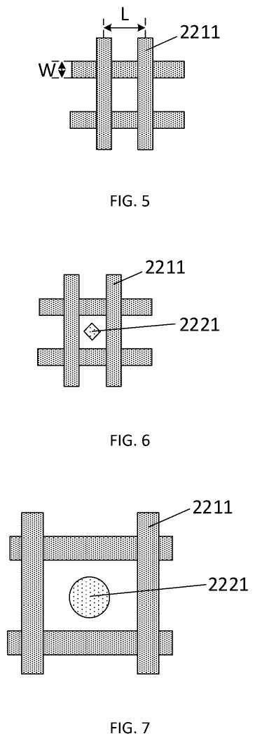

In some embodiments, in the phase shifter provided in embodiments of the present disclosure, as shown in FIGS. 2 and 4, the metal wire 2211 is a straight line and the shape of the mesh is a square. As shown in FIGS. 5 and 6, FIG. 5 is a partial enlarged schematic diagram of FIG. 2, and FIG. 6 is a partial enlarged schematic diagram of FIG. 4. The width W of the metal wire 2211 and the side length L of the square mesh are both related to the working performance of the phase shifter. The width W of the metal wire 2211 and the side length L of the square mesh determine the radiation transmission efficiency in the direction (Z) perpendicular to the first substrate 11. At a specific frequency, an increase in the width W of the metal wire 2211 may result in a decrease in the surface wave propagation constant and a decrease in the surface impedance. The surface impedance of the two-dimensional transmission line is essentially the ratio of the tangential electric field to the tangential magnetic field on the surface of the metal wire 2211. Since the electric field has no tangential component on the surface of the metal wire 2211, when the width W of the metal wire 2211 increases, the tangential electric field component on the surface of the entire two-dimensional transmission line decreases, and the tangential magnetic field component increases, thereby reducing its surface impedance. When the width W of the metal wire 2211 is large enough so that the upper surface of the liquid crystal layer 3 is almost completely covered by the metal electrode layer 221, the tangential electric field on the surface is close to 0, but the tangential magnetic field still exists. At this time, the surface impedance is close to 0, and the electromagnetic wave cannot be transmitted in the direction (Z) perpendicular to the first substrate 11. Therefore, the width W of the metal wire 2211 needs to be less than one thirtieth of the wavelength of the operating frequency of the phase shifter to ensure that the electromagnetic wave can be transmitted in the direction (Z) perpendicular to the first substrate 11. The side length L of the square mesh directly determines the spatial frequency of the electromagnetic wave, that is, the physical period of the two-dimensional transmission structure directly determines the composition of its waves. At the same operating frequency, the larger the unit structure period (the sum of the width of a metal wire and the width of a mesh), the larger the surface impedance of the two-dimensional transmission line structure. The larger the unit structure period is, the smaller the percentage of the area occupied by the metal wire 2211 on the surface of the liquid crystal layer 3 is, so that the tangential electric field component of the surface electric field of the liquid crystal layer 3 increases, which increases the surface impedance. Therefore, the side length L of the square mesh is less than one tenth of the wavelength of the operating frequency of the phase shifter to ensure that the electromagnetic wave can be transmitted in the direction (Z) perpendicular to the first substrate 11.

In some embodiments, as shown in FIGS. 4 and 5, the widths W of the metal wires 2211 in the entire layer are the same, and the side lengths L of the square meshes in the entire layer are the same. Of course, the widths W of the metal wires 2211 in the entire layer and the side lengths L of the square meshes are not necessarily fixed and the same, but may also be gradual, periodic or Taylor distributed, etc. Different grid structures of a two-dimensional transmission line can be designed according to different application scenarios. In a grid two-dimensional transmission line structure with gradual changes in W and L, the output signal powers of respective coupling ports 4 are not equal. The signal energy output by the coupling port 4 located at a smaller mesh is weaker, and the signal energy output by the coupling port 4 located at a larger mesh is stronger. The widths W of the metal wires 2211 and the side lengths L of the square meshes can be designed to change regularly according to different application scenarios.

In some embodiments, as shown in FIG. 4, FIG. 4 takes the shape of the mesh as a square as an example, of course, it is not limited to this. For example, the shape of the mesh can also be designed to be circular, triangular and Z-shaped, and the shapes of the meshes can also be designed to be a combination of any two, three or four of square, circular, triangular, and Z-shaped. Preferably, the shapes of the meshes are the same, so that the manufacturing process can be unified. The diameter of the circular mesh, the side length of the triangular mesh and the vertical distance between two horizontal sides of the Z-shape mesh are all less than one tenth of the wavelength of the operating frequency of the phase shifter to ensure that the electromagnetic wave can be transmitted in the direction (Z) perpendicular to the first substrate 11. In addition, the area of the electromagnetic field cut by the circular or triangular mesh is smaller than that cut by the square mesh, so for the circular or triangular mesh, the upward coupling efficiency of the electromagnetic field is low and the efficiency of planar transmission is high. The area of the electromagnetic field cut by the Z-shaped mesh is larger than that cut by the square mesh, so for the Z-shaped mesh, the upward coupling efficiency of the electromagnetic field is high and the efficiency of planar transmission is low. The shape of the mesh is selected according to actual needs.

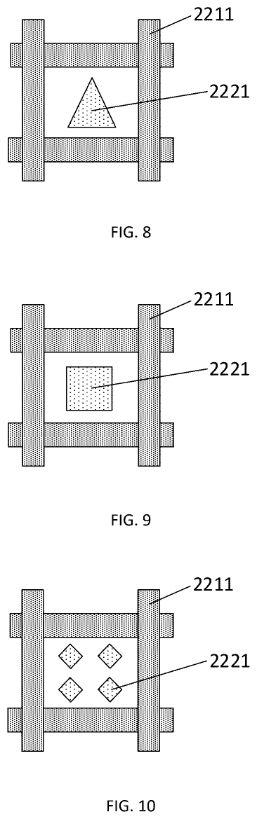

In some embodiments, in the phase shifter provided in embodiments of the present disclosure, as shown in FIGS. 3, 4 and 6, the shape of the transparent conductive portion 2221 is a rhombus. Of course, the shape of the transparent conductive portion 2221 can also be a rectangle, a circle or a triangle, but is not limited thereto. For example, as shown in FIG. 7, the shape of the transparent conductive portion 2221 is a circle. The pattern of the circular transparent conductive portion 2221 is convenient and simple, and easy to manufacture. As shown in FIG. 8, the shape of the transparent conductive portion 2221 is a triangle. The pattern of the triangular transparent conductive portion 2221 is convenient and simple, and easy to manufacture. As shown in FIG. 9, the shape of the transparent conductive portion 2221 is a rectangle. The pattern of the rectangular transparent conductive portion 2221 is convenient and simple, and easy to manufacture. Of course, the shapes of the transparent conductive portions 2221 can also be a combination of any two or three or four of rhombus, rectangle, circle and triangle. Preferably, the shapes of the transparent conductive portions 2221 are the same, so that the manufacturing process can be unified.

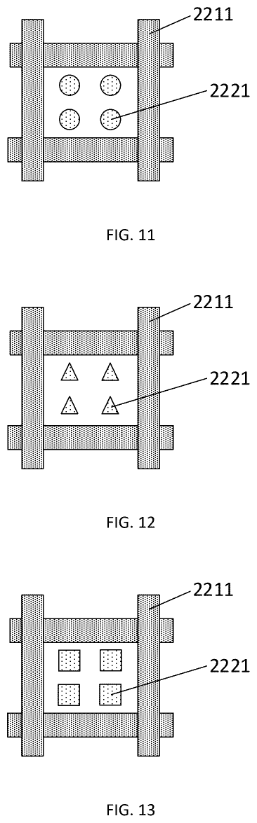

In some embodiments, in the phase shifter provided in embodiments of the present disclosure, as shown in FIG. 6 to FIG. 9, the number of transparent conductive portions 2221 disposed in each mesh is one. Of course, the number of transparent conductive portions 2221 set in each mesh can also be greater than one, as shown in FIGS. 10 to 13. FIGS. 10 to 13 all take four transparent conductive portions 2221 set in one mesh as an example. In this way, multiple transparent conductive portions 2221 are set in one mesh, and the area for regulating the liquid crystal molecules of the liquid crystal layer 3 is larger, so that more liquid crystal molecules are deflected, which is beneficial to regulating the change of the dielectric constant of the liquid crystal layer 3.

In some embodiments, in the phase shifter provided in embodiments of the present disclosure, the material of the transparent conductive portion can be indium tin oxide (ITO), boron-doped zinc oxide (BZO), aluminum-doped zinc oxide (AZO), etc.

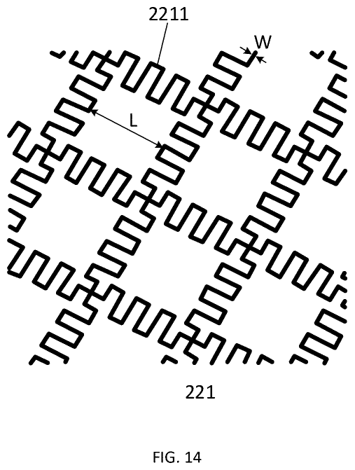

Of course, In some embodiments, the metal wire 2211 in the phase shifter can also be a curved line. For example, as shown in FIG. 14, the metal wire 2211 adopts a metal coiled shape, which increases the surface current intensity by extending the path of the current on the upper surface of the liquid crystal layer 3, thereby increasing the evanescent field intensity on the upper surface, providing higher efficiency for the energy coupling of electromagnetic waves.

Preferably, as shown in FIG. 14, the width W of the metal wire 2211 is less than one thirtieth of the wavelength of the operating frequency of the phase shifter, and the side length L of the square mesh formed by the metal coil is less than one tenth of the wavelength of the operating frequency of the phase shifter to ensure that the electromagnetic wave can be transmitted in the direction (Z) perpendicular to the first substrate 11.

In some embodiments, in the phase shifter provided in embodiments of the present disclosure, as shown in FIG. 1 and FIG. 4, the orthographic projection of one coupling port 4 on the first substrate 11 may cover the orthographic projections of multiple meshes on the first substrate 11. In this way, the mesh size of the metal electrode layer 221 can be set to be smaller, which is conducive to realizing the simultaneous operation of multiple phase shifters.

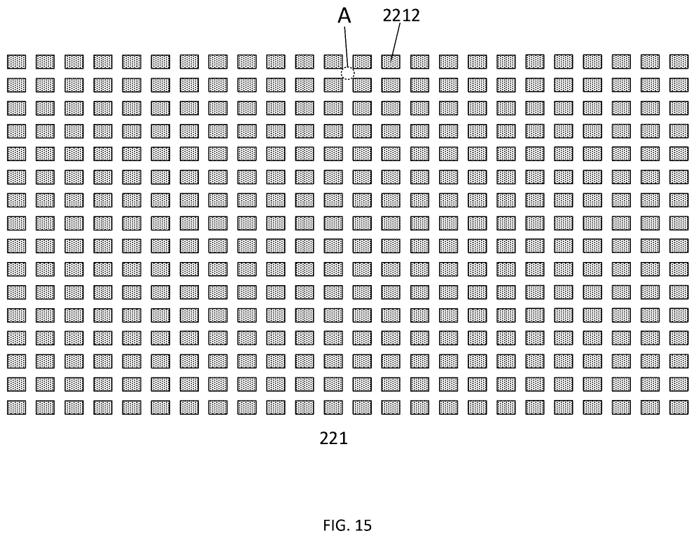

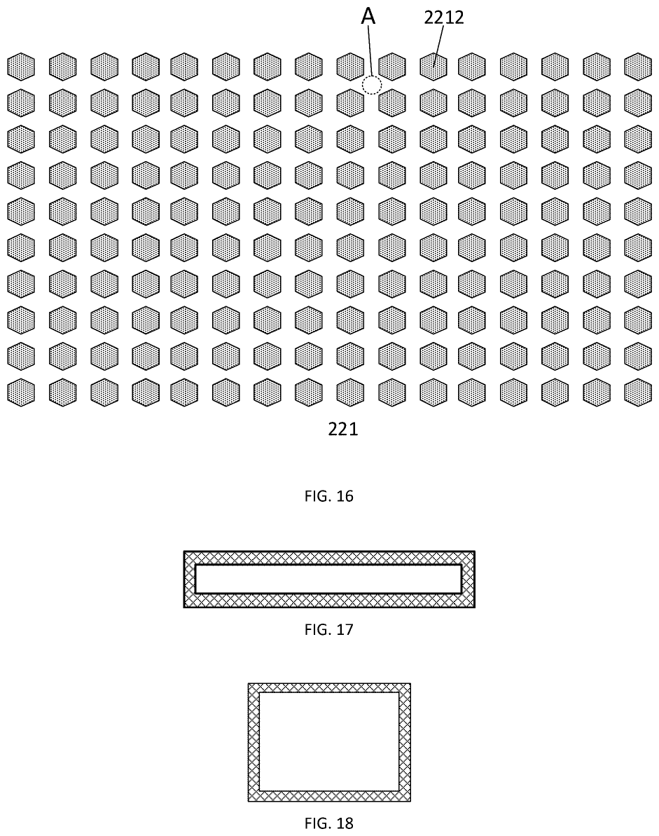

In some embodiments, in order to simplify the design and processing and manufacturing process, in the phase shifter provided in embodiments of the present disclosure, as shown in FIG. 15 and FIG. 16, the metal electrode layer 221 may also be configured to include a plurality of block sub-electrodes 2212 distributed in an array. Gaps between the plurality of block sub-electrodes 2212 form a grid pattern.

The transparent conductive portions 2221 shown in FIG. 3 may be disposed at gaps between a plurality of block sub-electrodes. In this way, the electromagnetic wave can propagate in two dimensions (a direction parallel to the first substrate and a direction perpendicular to the first substrate). For example, the transparent conductive portion 2221 may be disposed at the grid point A of the grid pattern, or between two adjacent block sub-electrodes 2212 in the horizontal direction X, or between two adjacent block sub-electrodes 2212 in the longitudinal direction.

Optionally, the shape of the block sub-electrode includes at least one of the following: circular, rectangular, and hexagonal. For example, as shown in FIG. 15, the shape of the block sub-electrode 2212 is a rectangle. As shown in FIG. 16, the shape of the block sub-electrode 2212 is a hexagon. The coupling efficiency of the phase shifter with the block sub-electrode 2212 shown in FIG. 16 is higher than that with the block sub-electrode 2212 shown in FIG. 15.

Of course, the shapes of the block sub-electrodes 2212 can also be circular, or a combination of any two or three of circular, rectangular, and hexagonal. Preferably, the shapes of the block sub-electrodes 2212 are the same, so that the manufacturing process can be unified.

In some embodiments, in the phase shifter provided in embodiments of the present disclosure, the orthographic projection of one coupling port 4 in FIG. 1 on the first substrate 11 may cover the orthographic projections of multiple transparent conductive portions 2221 on the first substrate 11. In this way, the number of transparent conductive portions 2221 can be increased, which is conducive to realizing the simultaneous operation of multiple phase shifters.

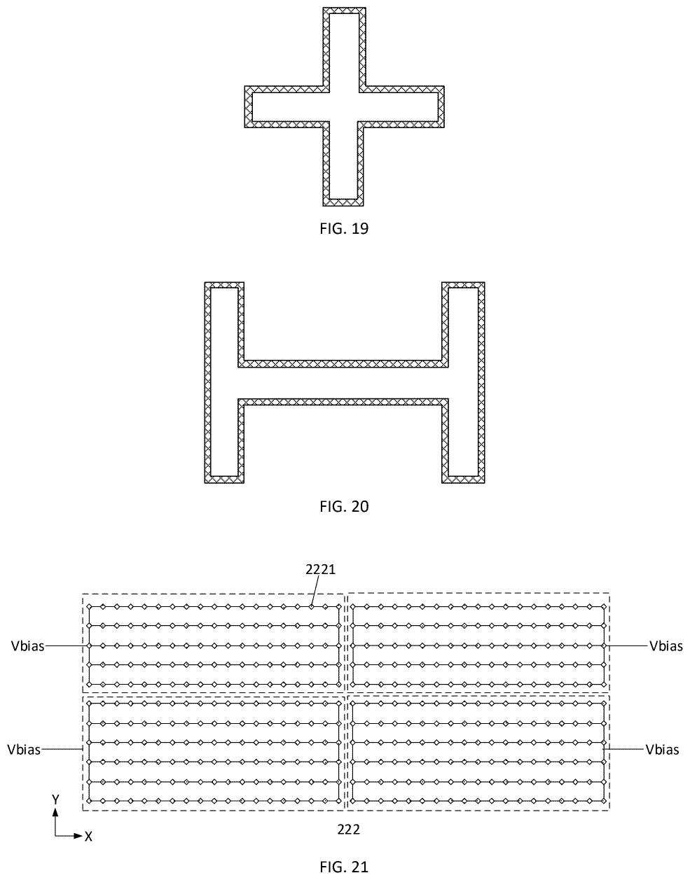

In some embodiments, in the phase shifter provided in embodiments of the present disclosure, the shape of the coupling port 4 includes at least one of the following: an “I”-shaped port, a rectangular port, a “+”-shaped port, and an “I”-shaped port. For example, as shown in FIG. 17, the shape of the coupling port 4 is an “I”-shaped port. As shown in FIG. 18, the shape of the coupling port 4 is a rectangular port. As shown in FIG. 19, the shape of the coupling port 4 is a “+”-shaped port. As shown in FIG. 20, the shape of the coupling port 4 is an “I”-shaped port. Of course, the shapes of the coupling ports 4 can also be a combination of any two, three or four of the “I”-shaped port, the rectangular port, the “+”-shaped port, and the “I”-shaped port. Preferably, the shapes of the coupling ports 4 are the same, so that the manufacturing process can be unified.

In some embodiments, coupling ports of different shapes can be selected according to different application scenarios. There are multiple coupling ports. The number of coupling ports is selected according to different application scenarios, and is generally an exponential power of 2. Since electromagnetic waves with different phases can be output simultaneously from different coupling ports, the arrangement of multiple coupling ports is equivalent to having more phase shifters working simultaneously, so that the phase shifter disclosed in the present invention has higher flexibility.

For example, the coupling port can be an I-shaped port, a rectangular port, a +-shaped port, or an I-shaped port formed of metal material, that is, the coupling port is hollow in the middle and is made of metal material on the periphery.

In some embodiments, in the phase shifter provided in embodiments of the present disclosure, as shown in FIGS. 1 and 21, bias voltage lines Vbias arranged in the same layer and made of the same material as the transparent conductive portions 2221 are also included. The second substrate 2 is divided into multiple areas. The transparent conductive portions 2221 in the same area are electrically connected to the same bias voltage line Vbias, and the transparent conductive portions 2221 in different areas are electrically connected to different bias voltage lines Vbias. In this way, the transparent conductive portions 2221 in different areas can be loaded with different driving voltages, so as to couple microwave signals of different phases from different coupling ports of the film layer where the coupling ports 4 are located, and realize that one phase shifter is equivalent to multiple phase shifters working simultaneously. Therefore, the phase shifter based on a two-dimensional transmission line provided by the present disclosure has high flexibility.

It should be noted that FIG. 21 takes the second substrate 2 divided into four areas as an example. Of course, the second substrate 2 can be divided into more areas. The more areas there are, the more phase shifters there are, but the complexity of the process for manufacturing the bias voltage line Vbias will increase. Therefore, the design should be based on actual needs.

It should be noted that since the bias voltage lines Vbias and the transparent conductive portions 2221 are in the same layer, made of the same material, and are electrically connected, the bias voltage lines Vbias are also electrically connected to the metal electrode layer 221. That is, the metal electrode layer 221 is not only used to transmit electromagnetic waves, but also to receive driving voltage, which is beneficial to adjusting the overlapping capacitance value of the electrode structure 22 and the ground metal layer 12 or the deflection of the liquid crystal.

For example, as shown in FIG. 1, the phase shifter provided in embodiments of the present disclosure further includes a common voltage line (not shown) electrically connected to the ground metal layer 12. The common voltage line is used to load a common voltage to the ground metal layer 12.

In some embodiments, in the phase shifter provided in embodiments of the present disclosure, as shown in FIG. 1, the material of the ground metal layer 12 and the material of the metal electrode layer 221 can be low-resistance, low-loss metals such as copper, gold, and silver. The ground metal layer 12 and the metal electrode layer 221 can be prepared by magnetron sputtering, thermal evaporation, electroplating, and the like. Depending on the thickness of the ground metal layer 12 and the metal electrode layer 221, different methods can be selected to prepare the the ground metal layer 12 and the metal electrode layer 221. In order to improve the performance of the phase shifter, preferably, the thickness of the ground metal layer 12 and the thickness of the metal electrode layer 221 are both greater than

$$\sqrt{\frac{2}{ω μ γ}} .$$

Here, ω is an angular frequency, μ is the magnetic permeability, and γ is the electrical conductivity.

In some embodiments, the phase shifter provided by the present disclosure may also include other functional film layers well known to those skilled in the art, which are not listed here one by one.

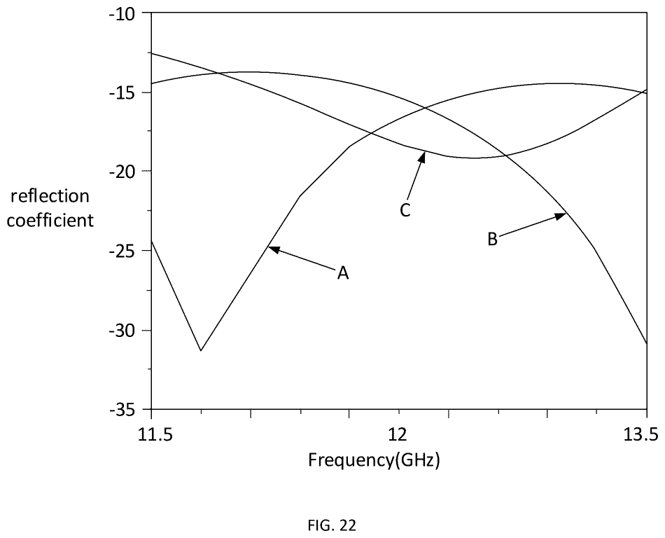

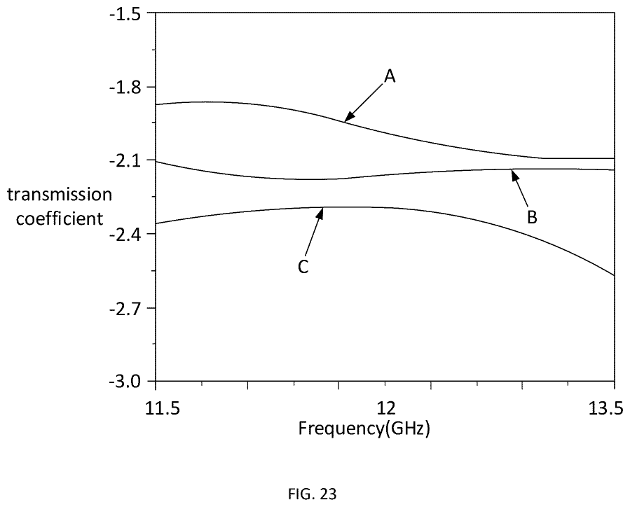

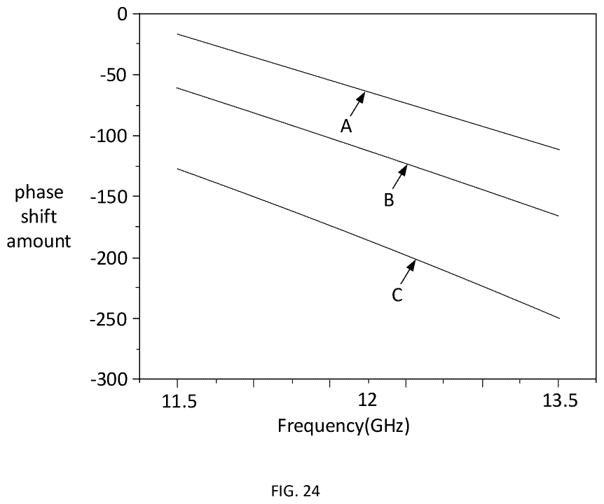

As shown in FIGS. 22 to 24, FIGS. 22 to 24 are respectively schematic diagrams of simulations of the reflection coefficient, transmission coefficient and phase shift amount between the electromagnetic wave input port (port1) and the electromagnetic wave output port (port2) of the liquid crystal phase shifter based on a two-dimensional transmission line shown in FIG. 1. Curve A corresponds to the transparent electrode layer loaded with a 0 V voltage, curve B corresponds to the transparent electrode layer loaded with a 10 V voltage, and curve C corresponds to the transparent electrode layer loaded with a 20 V voltage. It can be seen that the reflection coefficients under different voltages in FIG. 22 are all less than-10 dB, the transmission coefficients under different voltages in FIG. 23 are all greater than −10 dB, and the phase shift amounts under different voltages in FIG. 24 are all greater than −250. Therefore, the surface of the phase shifter based on the two-dimensional transmission line disclosed in the present invention (i.e., the surface of the second substrate 21) realizes coupling of signal energy with different phase shift amounts by adding multiple coupling ports 4. Electromagnetic waves with different phases are output simultaneously at different coupling ports, which is equivalent to multiple liquid crystal phase shifters working simultaneously. Compared with the liquid crystal phase shifter based on a one-dimensional transmission line, the liquid crystal phase shifter based on a two-dimensional transmission line disclosed in the present invention is more flexible.

In some embodiments, the dielectric layer can also use conventional dielectric materials. The dielectric constant of conventional dielectric materials will not change due to changes in the electric field. Therefore, the phase of the output signal at the electromagnetic wave output port (port2) and the coupling port 4 is fixed. If multiple output phase values are required, multiple coupling ports are needed.

Based on the same inventive concept, embodiments of the present disclosure further provide an antenna, including the above-mentioned phase shifter provided by embodiments of the present disclosure. The implementation of the antenna can refer to the above-mentioned phase shifter embodiments, and the repeated parts will not be repeated.

It should be noted that the number of phase shifters included in the antenna is determined according to actual needs and is not specifically limited in the embodiments of the present disclosure.

The antenna provided in embodiments of the present disclosure may be, for example, any product or component with a communication function, such as a mobile phone. Other essential components of the antenna should be understood by those skilled in the art and will not be described in detail herein and should not be construed as limiting the present disclosure. The implementation of the antenna can refer to the above-mentioned embodiments of the phase shifter, and the repeated parts will not be repeated.

A phase shifter and an antenna provided by embodiments of the present disclosure have a metal electrode layer with a grid pattern, and a plurality of coupling ports are arranged on a side of the second substrate away from the first substrate, so that electromagnetic waves can propagate in two dimensions (a direction parallel to the first substrate and a direction perpendicular to the first substrate). That is, the phase shifter provided by the present disclosure is a phase shifter based on a two-dimensional transmission line. Signal energy can be coupled and transmitted on the surface of the two-dimensional transmission line, so that coupling of signal energy with different phase shift amounts can be achieved through a plurality of coupling ports. Signals and energy can be extracted at different coupling ports, and electromagnetic waves with different phases can be output simultaneously at different coupling ports, which is equivalent to multiple phase shifters working simultaneously. Therefore, compared with the traditional phase shifter based on a one-dimensional transmission line, the phase shifter based on a two-dimensional transmission line provided by the present disclosure has higher flexibility. The phase shifter based on a two-dimensional transmission line provided by the present disclosure has a relatively simple structure, a low manufacturing cost, can be laid over a large area, and has strong practicality.

Obviously, those skilled in the art can make various changes and modifications to the present disclosure without departing from the spirit and scope of the present disclosure. Thus, if these modifications and variations of the present disclosure fall within the scope of the claims of the present disclosure and their equivalent technologies, the present disclosure is also intended to include these modifications and variations.

1. A phase shifter, comprising:
a first base substrate and a second base substrate arranged opposite to each other,
a dielectric layer between the first base substrate and the second base substrate, and
a plurality of coupling ports, arranged at intervals on a side of the second base substrate away from the first base substrate; wherein
the first base substrate comprises:
a first substrate, and
a ground metal layer on a side of the first substrate facing the dielectric layer;
the second base substrate comprises:
a second substrate, and
an electrode structure on a side of the second substrate facing the dielectric layer;
wherein the electrode structure comprises:
a metal electrode layer, and
a transparent electrode layer,
wherein the metal electrode layer is provided with a grid pattern, the transparent electrode layer comprises a plurality of transparent conductive portions distributed in an array, and an orthographic projection of the transparent conductive portions on the first substrate does not overlap with an orthographic projection of the grid pattern of the metal electrode layer on the first substrate.

2. The phase shifter according to claim 1, wherein the metal electrode layer comprises:
a plurality of metal wires that are crisscrossed and spaced apart;
wherein the plurality of metal wires form the grid pattern;
the transparent conductive portions are arranged in meshes of the grid pattern.

3. The phase shifter according to claim 2, wherein a width of the metal wire is less than one thirtieth of a wavelength of an operating frequency of the phase shifter.

4. The phase shifter according to claim 3, wherein a shape of the mesh comprises at least one of a square, a circle, a triangle, or a Z-shape;
a side length of the square, a diameter of the circle, a side length of the triangle, and a vertical distance between two horizontal sides of the Z-shape are all less than one tenth of the wavelength of the operating frequency of the phase shifter.

5. The phase shifter according to claim 2, wherein a quantity of the transparent conductive portions arranged in each of the meshes is greater than or equal to one.

6. The phase shifter according to claim 2, wherein the metal wire comprises a straight line or a curved line.

7. The phase shifter according to claim 2, wherein an orthographic projection of one of the coupling ports on the first substrate covers an orthographic projection of a plurality of the meshes on the first substrate.

8. The phase shifter according to claim 1, wherein the metal electrode layer comprises:
a plurality of block sub-electrodes distributed in an array;
wherein gaps between the plurality of block sub-electrodes form the grid pattern;
the transparent conductive portions are arranged at the gaps between the plurality of block sub-electrodes.

9. The phase shifter according to claim 8, wherein an orthographic projection of one of the coupling ports on the first substrate covers an orthographic projection of a plurality of the transparent conductive portions on the first substrate.

10. The phase shifter according to claim 7, wherein the coupling port comprises at least one of: an I-shaped port, a rectangular port, a +-shaped port, and an I-shaped port.

11. The phase shifter according to claim 1, further comprising:
bias voltage lines, arranged in the same layer and made of the same material as the transparent conductive portions;
wherein the second substrate is divided into a plurality of areas, the transparent conductive portions in the same area are electrically connected to the same bias voltage line, and the transparent conductive portions in different areas are electrically connected to different bias voltage lines.

12. The phase shifter according to claim 1, wherein a shape of the transparent conductive portion comprises at least one of: rhombus, rectangle, circle, or triangle.

13. The phase shifter according to claim 1, wherein a thickness of the ground metal layer and a thickness of the metal electrode layer are both greater than
$$\sqrt{\frac{2}{ω μ γ}} ;$$
wherein ω is an angular frequency, μ is a magnetic permeability, and γ is an electrical conductivity.

14. The phase shifter according to claim 1, wherein a material of the first base substrate and a material of the second base substrate are flexible materials.

15. An antenna, comprising the phase shifter according to claim 1.

16. The phase shifter according to claim 9, wherein the coupling port comprises at least one of: an I-shaped port, a rectangular port, a +-shaped port, and an I-shaped port.

17. The phase shifter according to claim 2, further comprising:
bias voltage lines, arranged in the same layer and made of the same material as the transparent conductive portions;
wherein the second substrate is divided into a plurality of areas, the transparent conductive portions in the same area are electrically connected to the same bias voltage line, and the transparent conductive portions in different areas are electrically connected to different bias voltage lines.

18. The phase shifter according to claim 8, further comprising:
bias voltage lines, arranged in the same layer and made of the same material as the transparent conductive portions;
wherein the second substrate is divided into a plurality of areas, the transparent conductive portions in the same area are electrically connected to the same bias voltage line, and the transparent conductive portions in different areas are electrically connected to different bias voltage lines.

19. The phase shifter according to claim 2, wherein a thickness of the ground metal layer and a thickness of the metal electrode layer are both greater than
$$\sqrt{\frac{2}{ω μ γ}} ;$$
wherein ω is an angular frequency, μ is a magnetic permeability, and γ is an electrical conductivity.

20. The phase shifter according to claim 8, wherein a thickness of the ground metal layer and a thickness of the metal electrode layer are both greater than
$$\sqrt{\frac{2}{ω μ γ}} ;$$
wherein ω is an angular frequency, μ is a magnetic permeability, and γ is an electrical conductivity.
